(19) United States
(12) Patent Application Publication
(10) Pub. No.: US 2014/0195311 A1
(43) Pub. Date: Jul. 10, 2014

(54) METHOD AND SYSTEM FOR INTEGRATING PRODUCTION, QUALITY AND REPOSITORY FUNCTIONS IN A COMPUTER-BASED MANUFACTURING SYSTEM

(71) Applicant: Fei Wang, Farmingdale, NY (US)

(72) Inventor: Fei Wang, Farmingdale, NY (US)

(21) Appl. No.: 13/737,843

(22) Filed: Jan. 9, 2013

(51) Int. Cl. G06Q 10/06

(52) U.S. Cl. CPC G06Q 10/06395
USPC 705/7.41

(57) ABSTRACT

A method, apparatus and program storage device for integrating a quality inspection system, a production system and a repository system in a computer-based manufacturing system.

### BACKGROUND OF THE INVENTION

1. Field of the Invention

The present invention described herein relates generally to a method and system for controlling the quality in pharmaceutical, metallurgy, food, cosmetic, and aerospace product manufacturing, and in particular, to a method and system designed to integrate material, production and inspection functions in an automated enterprises resource planning system and a product manufacturing system.

2. Description of the Related Art

Computer-based automation systems are typically designed to manage and communicate high-volume data at high speeds with other interconnected systems in a fixed network. An increasing number of these systems are being used in a variety of industries, especially in the goods manufacturing industries where complex process are common and where data volume and quality can be difficult to monitor and control.

In a single manufacturing plant, for example, the manufacturing, quality control, raw material purchasing and sales functions generally involve properly formulating large amounts of data to enhance and maximize end-product production efficiency. Companies often implement a plurality of stand-alone components or sub-systems in a fully automated manufacturing system to monitor and control each of these separate manufacturing functions. Problems arise when these separate sub-systems cannot effectively communicate with each other due to compatibility issues. In many cases, traditional automation systems are usually designed to include a plurality real-time process control systems with different interfaces. These fully automated systems are capable of allowing operators to provide specific real-time processing control capabilities and to retrieve, in real-time, data relating to each specific manufacturing process function.

As such, there is needed a method and system for seamlessly integrating different stand-alone production, quality and repository functions within an automated network-based manufacturing system, thereby enhancing overall data management and control.

### SUMMARY OF THE INVENTION

An aspect of the present invention is to substantially solve at least the above problems and/or disadvantages and to provide at least the advantages below. Accordingly, one aspect of the present invention is to provide a method and system for integrating different stand-alone production, quality and repository functions within an automated network-based manufacturing system.

According to one aspect of the present invention, there is provided a method for integrating a quality inspection system, a production system and a repository system in a computer-based manufacturing system. The method includes collecting and storing materials information, production information and inspection information related to a product, wherein the information is stored in a database, linking the database to a planning system, a materials system, a product quality inspection system and a production system, a computer program generating a production plan order from the planning system, the computer program assigning a production task based on the production plan order, sending data concerning production requirements relating to manufacturing of the product to the production system, sending data concerning materials requirement relating to manufacturing of the product to the repository system, sending a materials test sample result to the quality inspection system if the repository system shows that the material does not meet a pre-set production requirement, sending a product test sample result to the quality inspection system if the repository system shows that the product needs to be inspected before a manufacturing process is performed, and sending the materials and product inspection test results to the material system and the production system.

According to one embodiment of the present invention, the method also includes the step of linking the planning system, the materials system, the quality control system and the production system.

According to yet another embodiment of the present invention, sending the materials test result data to the database from the inspection system.

According to yet another embodiment of present invention, the correlation among the planning system, material system, quality control systems and production systems are based on the database configuration without the need for a special interface.

According to one embodiment of the present invention, the material system generates a different color representing product quality status, wherein a “yellow” color indicates a product quarantine quality status, wherein a “green” color indicates that a product has passed a quality inspection and can be used in the process of production, and wherein a “red” color indicates the product is unacceptable.

According to one embodiment of the present invention, the integration among the quality inspection system, the quality control standards and the quality control processes are based on a pre-set configuration system.

According to another aspect of the present invention, there is provided a computer-based system for integrating a quality inspection system, a production system and a repository system in an automated manufacturing system. The computer-based system includes a storing means for collecting materials information, production information and inspection information related to a product wherein the information is stored in a database, a linking means for linking the database to a planning system, a materials system, a product quality inspection system and a production system, a generating means for generating a production plan order by the planning system, an assigning means for assigning a production task, a first sending means for sending data concerning production requirements to manufacture a product to the production system, a second sending means for sending data concerning materials requirement to manufacture a product to the repository system, a third sending means for sending a materials test sample result to the quality inspection system if the repository system shows that the materials does not meet a pre-set product requirement, a fourth sending means for sending a test sample result to the quality inspection system to inspect if a product needs to be inspected before a manufacturing process is performed, and a fifth sending means for sending the inspection result to the material system and the production system.

According to still another embodiment of the present invention, there is provided an apparatus for integrating a quality inspection system, a production system and a repository system in an automated product manufacturing system. The apparatus includes a memory for storing program instructions and a processor, configured according to the program instructions for collecting material information, production information and inspection information related to a product and storing the information into a database, linking the database to a planning system, a materials system, a quality inspection systems and a production systems, generating a production plan order by the planning system, formulating product production tasks, sending data concerning the production requirements of a product to the production system, sending data concerning material requirement of a product to the repository system, sending material sample data to the quality inspection system, where if the repository system shows that the materials do not meet the production requirements then the material needs to be inspected, sending test sample data to the quality inspection system wherein test sample result data is generated, sending the inspection result data to a material system and a production system.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating data flow of an integrated product production system, product quality system and a product materials system according to the present invention;

FIG. 2 is a detailed data flow diagram as shown in FIG. 1 according to the present invention;

FIG. 3 is a computer display screen illustrating user formulation of production tasks and product raw material requirements relating to the manufacturing plan as shown in FIG. 2 according to the present invention;

FIG. 4 is a computer display screen shot generated by a graphical user interface illustrating the production equipment to be used in the production process according to the present invention;

FIG. 5 is a computer display screen shot illustrating product raw material information transmitted from a repository system as shown in FIG. 2 according to the present invention;

FIG. 6 is computer display screen shot generated by a graphic user interface illustrating production parameters configuration concerning product quality inspection information and manufacturing process information according to the present invention; and

FIG. 7 is a work list screen illustrating captured product material information in a repository system having quality status information generated by the inspection system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

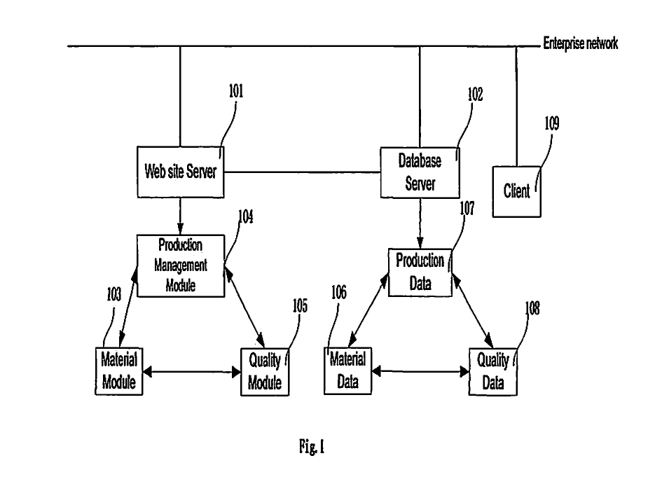

FIG. 1 is a schematic diagram illustrating data flow of an integrated product production system, product quality system and a product materials system according to the present invention.

WEB server 101 is a high-performance computer (HPC) within a computerized enterprise network and contains a system and a page program containing a materials module 103, a production module 104 and a quality module 105. WEB server 101 also provides an application software platform adapted to reply to client service requests via the Internet that submitted by user using a human-machine interface (HMI) workstation.

As to FIG. 1, the materials management module 103 contains a management program for managing materials in a warehouse and used in product batch processing. Management module 103 carries out material management functions by sending a production order command after receiving a request for a material transfer in, a material transfer out, material reception, material release, material inventory query, material test query. The production management module 104 is includes a management program for controlling and monitoring the product manufacturing execution function. In operation, the production management module 104 receives a request for a product plan, a batch production order, or a manufacturing process execution order. In addition, the production management module generates a product batch order and acquires manufacturing device parameter information for devices used in the production process.

Further in FIG. 1, the quality management module 105 is shown including laboratory information generated during product batch processing, and carries out a quality-control management function after receiving an information request for sampling, testing, or release of raw materials, auxiliary materials, or intermediate or finished products. Database server 102 is a high-performance computer database (DB) adapted to reply to the request submitted by WEB server 101 and provides service functions such as querying, updating, management, index, cache, query optimization, and safety and multi-user access control.

The material module 103, production module 104 and quality module 105 includes material data 106, production data 107, and quality data 108 respectively, and are stored in the database server 10 and each is interconnected without a setting interface. Material data 106 is shown in the warehouse information section of the material module 103, containing information relating, but not limited, to the quantity, state, expiration date, and material transfer. Production data 107 contains the manufacturing execution system function of the production module 104. Production data 107 includes information relating to production devices, device parameters settings, production staff, and different production lines.

Quality data block 108 contains information generated from module 105 and includes information relating to raw materials testing, auxiliary materials, and intermediates materials used in product batch processing. Quality data 108 also includes, but is not limited to, information relating to (i) items used in raw materials testing, (ii) raw materials testing standards, (iii) finished end-product testing processes, (iv) production equipment and device operations, and (v) testing staff information.

Module 109 is an end-user operations system and, via WEB server 101, generates data from materials module 103, production module 104, and quality module 105. Through module 109 users can input information, save page data, and send data to database server 102. In operation, when material data 106, production data 107, quality data 108 changes, information in other module will update automatically, hence resulting in information uniformity. In another embodiment of the present invention, the database server 102 may be linked to an enterprise resource planning (ERP) system and wherein the ERP system can share resource planning data with the production planning system, materials system, quality control system and the production system.

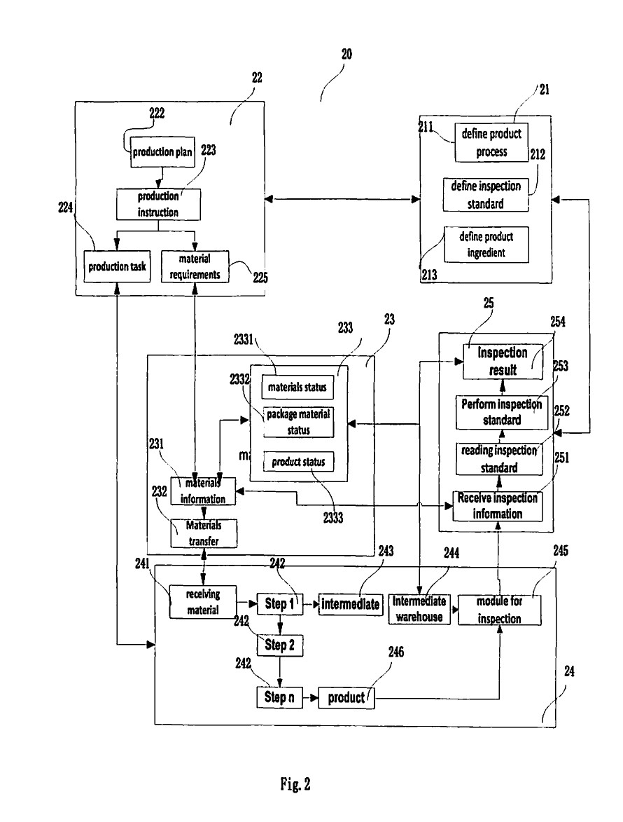

FIG. 2 is detailed data flow diagram as shown in FIG. 1 according to the present invention. According to one embodiment of the present invention, system 20 includes a configuration system 21, a plan system 22, a repository system 23, a production system 24 and an inspection system 25. In another embodiment, systems 21, 22, 23, 24 or 25 can be implemented as a single stand-alone system or as a distributed system, or any combination thereof. System 20 may be stored on a single computer or a plurality of computers, or any combination thereof, to perform their specified functions thereof.

Configuration system 21 is a database used to receive, classify, process, define and configure data relating to product manufacturing plans, raw materials repository and storage, and a product production line or finished-product inspection. Furthermore, the configuration system 21 may assist users involved in production planning to generate reports relating to production planning, finished-product repository and storage, and manufacturing production lines monitoring and inspection. For example, in an illustrated embodiment, the configuration system 21 includes a definition module consisting of a product process 211, a definition module consisting of an inspection standard 212 and definition module consisting of product ingredient 213. The definition module of the product process 211 is configured to receive, classify, process, define and configure data needed for process procedures, process sequencing, process parameter and process standard and other data related to the overall production process. The definition module of the inspection standard 212 is designed to receive, classify, process, define and configure data related to a corresponding product. The definition module of the product ingredient 213 is used to receive, classify, process, define and configure data related to (1) intermediate raw material, (2) packing material and inspection methods thereof, (3) raw material inspection standards, (4) raw material inspection results, and other data concerning inspection. According to another embodiment of the present invention, the configuration system 21 may be adapted to include different functional modules.

Planning system 22, repository system 23, production system 24 and inspection system 25 can compatibly communicate with the configuration system 21. Similarly, configuration system 21, is designed to receive, classify, process, define and configure data related to production planning information, product repository and storage information, production and quality inspection information, as well as to assist users in formulating a production plan and to generate reports or other functions with respect to (a) production planning, (b) product repository and storage, and (c) product manufacturing line control and inspection. The detailed functional descriptions relating to the planning system 22, the repository system 23, the production system 24 and the inspection system 25 will be described below.

As shown in FIG. 2, planning system 22 including production planning data module 222, a plurality of batch instruction data 223 comprising production task data 224 and the material requirements data 225. Production planning module 222 enables users to determine the quantity and production date of a manufactured product. For example, once production planning has been determined, the production plan data is sent to the next process in the form of a production order data, wherein production instruction data 223 includes production task data 224 and the material requirements data 225. According to one embodiment of the invention, the production task data includes, but is not limited to (a) production equipment data, (b) production process data, (c) production steps data and (d) production process data and all of which will be sent to the production system 24. According to one embodiment of the present invention, the material requirements data 225 includes, but is not limited to, the variety of materials data, the amount of materials data, and the material quality standards data. Material requirement data 225 will be automatically sent to the warehouse system. According to other embodiments, the planning system 22 can include other, less, and/or different functional modules.

In FIG. 2, repository system 23 includes the quality status module 233, the materials information data 231 and the transfer data 232 of the repository. According to yet another embodiment of the invention, the quality status module 233 includes raw materials status data 2331, the package material status data 2332 and final product status data 2333 wherein all of the above-mentioned data is timely shared from the quality inspection system 25 after the corresponding examination has been completed. All the above-mentioned quality status data is updated and shared with materials information data which reflects the most recent quality status data in the quality status modules. If the quality status of materials of the repository is inconsistent with pre-set product testing standards, or materials are waiting for inspection, the system will automatically submitted information for inspection to the quality inspection system 25 where the information inspection module exists, and wherein the information inspection module is used to make the appropriate testing procedures to meet the appropriate test requirements, and the next step will not implemented until the materials information satisfy the pre-set requirement. Specific inspection workflow will be described below. As illustrated in FIG. 2 when the repository materials information satisfy the requirement for issuing, the system will perform data transferring step 232 and the material information data is sent to the production system 24. According to other embodiments, repository system 23 may include other, less and/or different functional modules.

When the production task data 224 from the planning system is sent to the production system 24, production system 24 will perform pre-production inspection and preparation to confirm whether the various preparation tasks have been finished. When the material data from repository system 23 is sent to production position, production system 24 will initiate the production process. In FIG. 2, the production system 24 includes receiving raw material information data module 241, a series of production process steps 242, data information of Intermediates 243 and intermediate product warehouse 244 used to store intermediate products and the final finished-product information data 246 once the final process step 242 has been completed,

When the intermediate product 243 generated by a manufacturing step 242 was transferred to repository 244 and after completing the last process step 242, product information data 246 is generated, the production system 24 will send intermediate data or refined data to the inspection system 25 through module for inspection 245.

In FIG. 2, the quality inspection system 25 is designed to transfer information data that may need to be inspected to the next manufacturing step by accepting information for the inspection module. Inspection and testing may be needed if the product raw materials and packaging materials are waiting for inspection after the aforementioned materials has been transferred to the storage repository, and if the quality status of the materials in the repository is inconsistent with pre-set product testing standards, or if an intermediate or finished-product is in need of inspecting. Once the inspection data has been received, the system will perform the step 252 about reading inspection standard 252 from configuration system 21, and then the system performs the inspection procedure 253, wherein the result is then transferred to a different system in accordance with a different inspection method. As illustrated in FIG. 2, the results of inspection 254 are transferred to the repository system 23 and the production system 24 separately. According to other embodiments, the inspection system 24 can include other, less, and/or different functional modules.

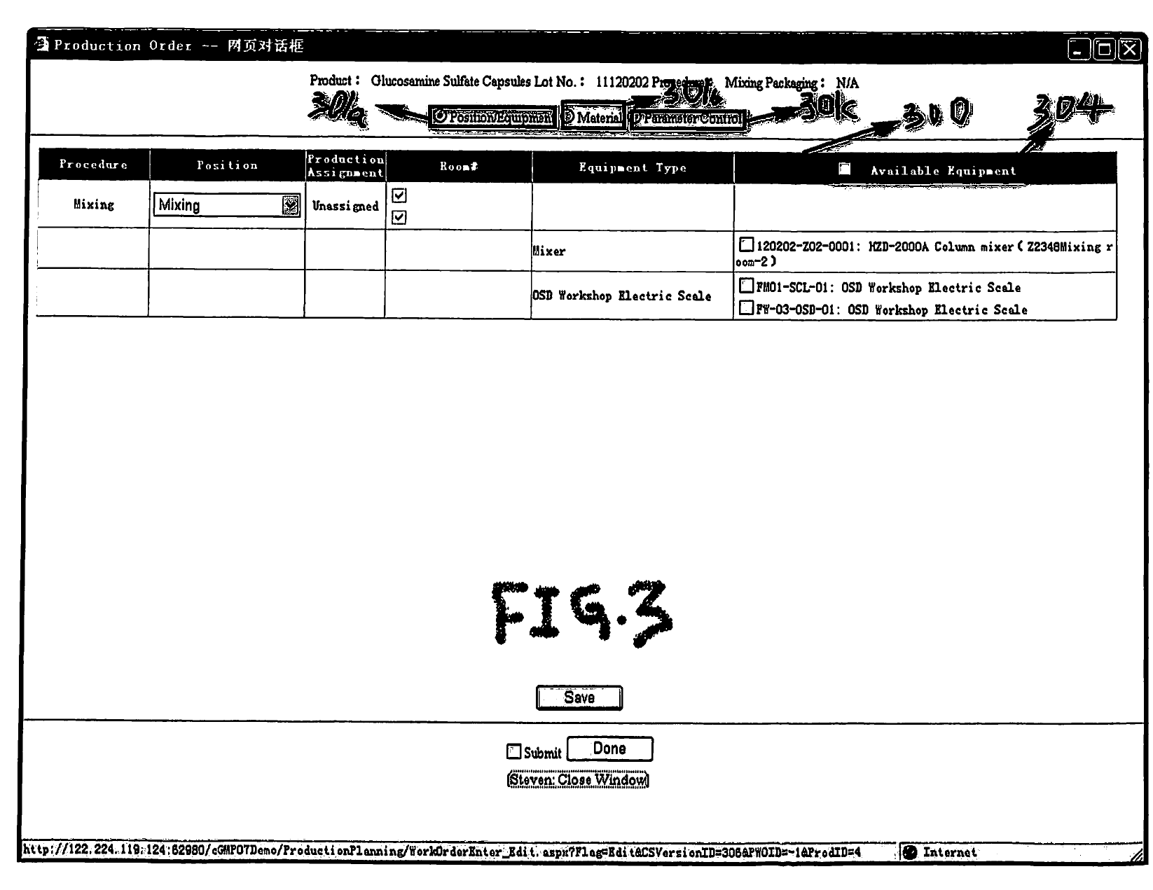

FIG. 3 is a computer display screen illustrating a user formulation of production tasks and product raw material requirements relating to the manufacturing plan as shown in FIG. 2 according to the present invention

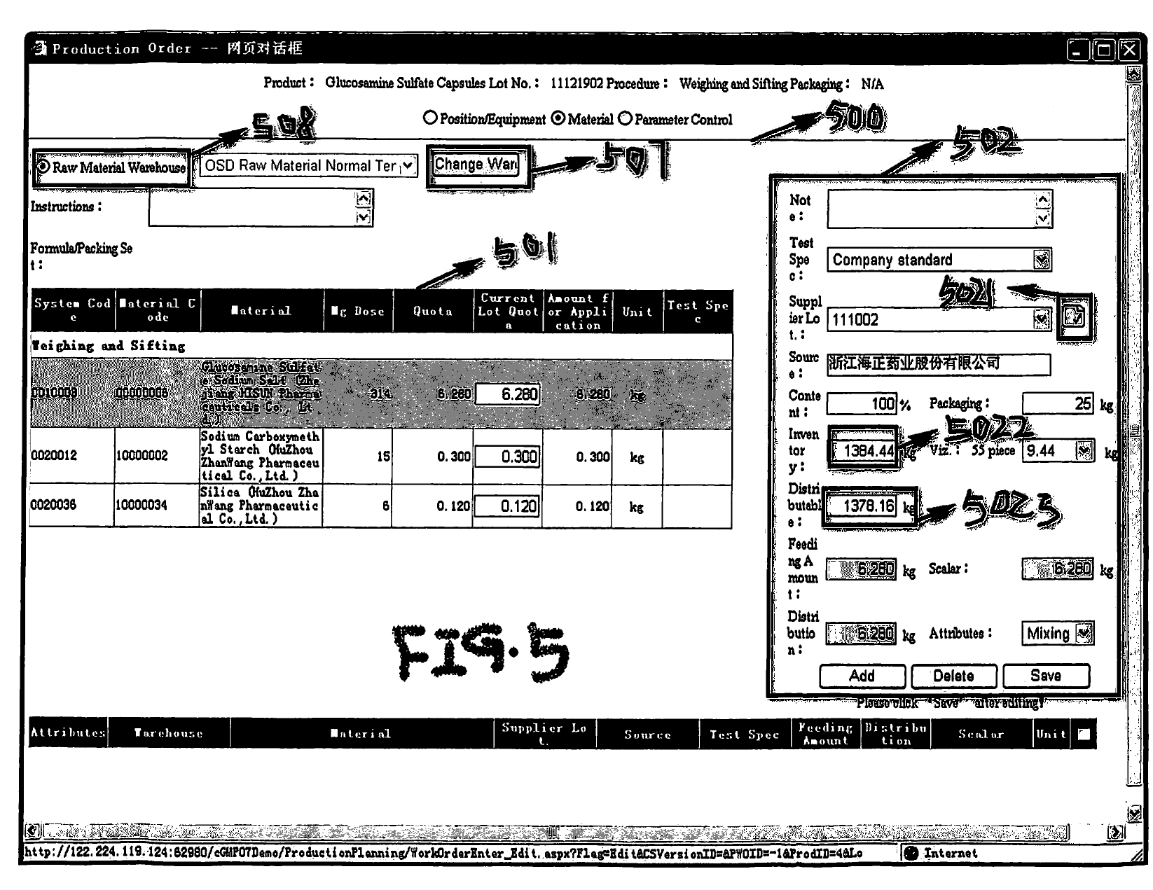

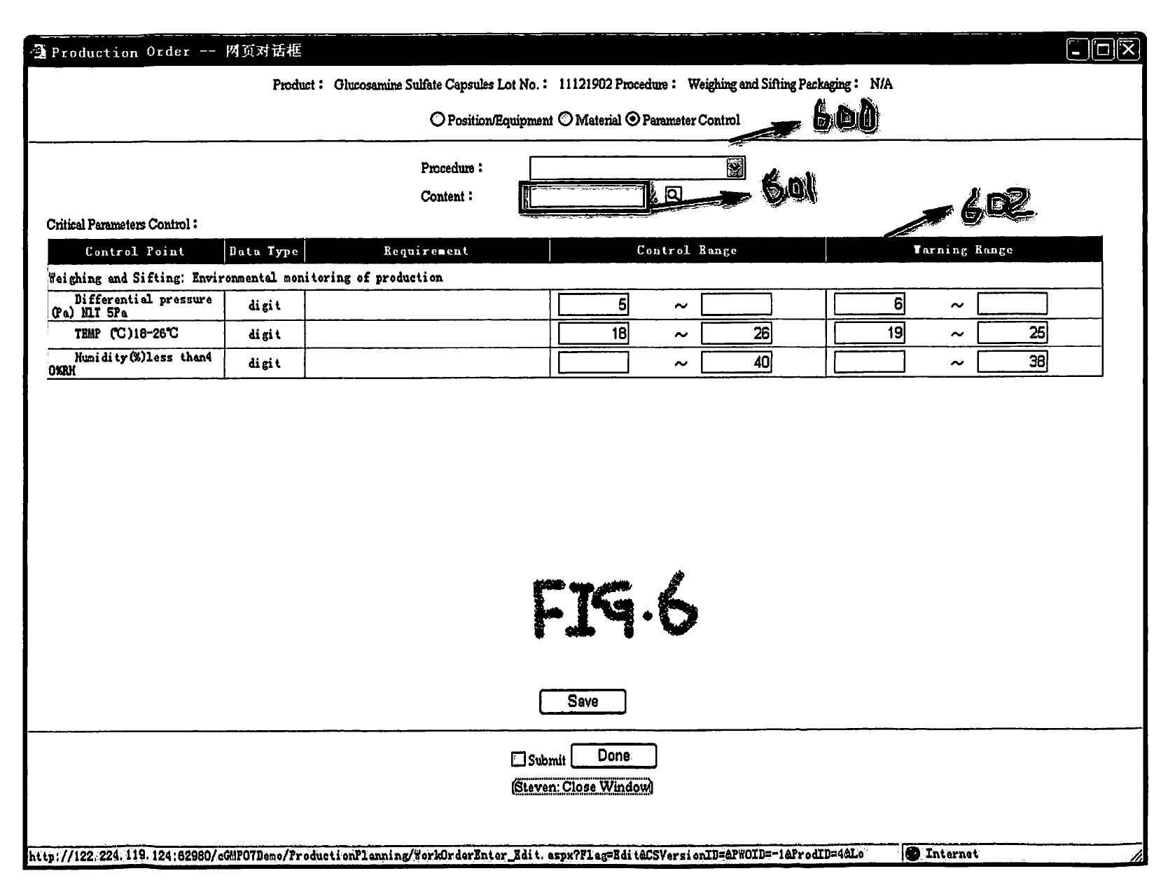

In FIG. 3, a header row 301 includes link 301 labeled “equipment and position”, link 301b labeled “material” and link 301c labeled “parameter control”. Link 301a includes table 300 that further includes a plurality of equipment information available to completing certain cycle manufacturing plan and is then displayed on a user screen. Exemplary information comprise, link 302 labeled “arrangement of production” indicates whether the production is initiated or not, link 303 labeled “type of the equipment” included all the types of equipment to be used in a manufacturing plant, and link 304 labeled “available equipment” includes all of the equipment to be used in a manufacturing plan in the header row of table 300. In addition, a user can select specific equipment to be use in production by selecting a “select” box next to each corresponding equipment item shown in link 304, or users may select all of the equipment choices listed by selecting a select box located above link 304. All the equipment information data and data related to production currently in-progress can be transferred from the production system and are then grouped together to be selected by the user. When a user selects links 301b and 301c, respective user graphic interfaces are displayed, as seen in FIGS. 5 and 6, as described below.

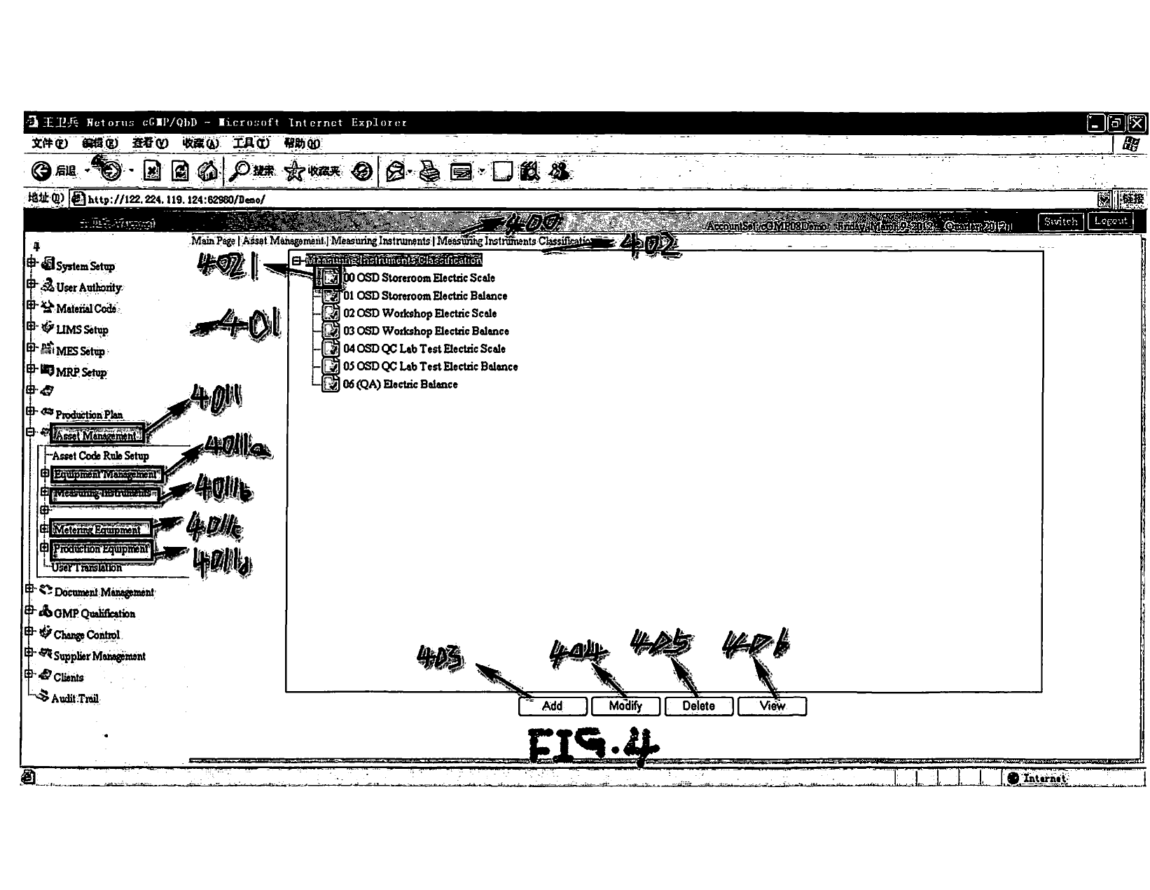

FIG. 4 is an example of computer display screen shots generated by a user interface with respect to the equipment required to be used in the production process according to the present invention. As shown in FIG. 4, the work list interface 400 may be configured to display a list of functions link in hierarchical listing 401 including a link 4011 labeled “management of asset”, which further includes 4011a labeled “equipment management”, a link 4011b labeled “equipment management”, a link 4011c labeled “metering equipment”, a link 4011d labeled “production equipment”, Within the drop down list of 4011a, if a right click performed on the link labeled “equipment class”, a table 402 including a plurality of equipments associated with certain production plan is displayed on the screen as shown in FIG. 4. The mark 4021 indicates that the availability status of the equipment or its qualification to be used for completing a predetermined production plan. All of the equipment information data is transferred from the production system 23, as shown in FIG. 2, and allows a user to know the detailed information related to production currently in progress and to implement production countermeasures in advance. Below table 402, a row of function buttons are shown wherein button 402 is labeled “adding”, button 403 is labeled “modifying”, button 404 is labeled “deleting” and button 405 labeled “checking” In operation, buttons 402, 403, 404, and 405, when activated, allow a user to add, modify, delete and check equipment information into or from table 402. The application method and result of link 4011b, link 4011c and link 4011d are the same as those found in link 4011 and will not be described herein.

FIG. 5 is a computer display screen shot of a user interface illustrating product raw material information transmitted from a repository system as shown in FIG. 2 according to the present invention.

In FIG. 5, user interface 500 includes link 508 labeled “raw material warehouse”, indicating where materials for production are stored, a button 507 labeled “reselecting repository” for facilitating to user to select repository and a table 501 included material information items associated with a certain production plan. Exemplary material item information includes information relating to material identification, dosage, quantity, current lot quantity and finished-product application quantity. When a user selects the second row in table 501, table 502 is displayed. Table 502 includes a mark 5021 indicating the status of the quality of the selected material, link 5022 represents the quantity of inventory of the selected material, and link 5023 indicates the available quantity of the selected material. According to one embodiment of the present invention, mark 5021 is shown as a green color indicator denoting that the material is qualified for release to the production line. Almost all of the material information data is transferred from the repository system 24 shown in FIG. 2, and the quality status of material as denoted in mark 5021 is transferred from the inspection system 25. Based on the user interface shown in FIG. 5, a user can obtain material information from the repository on time and in real-time.

FIG. 6 is computer display screen shot generated by a graphic user interface illustrating production parameters configuration concerning product quality inspection information and manufacturing process information according to the present invention.

According to an exemplary embodiment, interface 600 includes field 601 into which a user can set values of the content of the product percentage by manually inputting and a table 602 represented scope of corresponding parameters of production environment, which can be achieved in configuration or by manually inputting. The parameters involved are those relating to processing procedure, processing sequencing, processing standards and inspection method, as well as parameters relating to inspection standards of intermediate, raw material and packing material. Parameter definition data can be transferred from the configuration system 21 by product process definition module 211, inspection standard definition module 212 or product ingredient definition module 213. If the actual production environment parameter exceeds the scope of any the pre-set, environment parameters, then, in response, an alarm program would trigger an alarm. After product content value has been defined, according to a predefined product formula, and the quantity of material the production plan required, the present invention allows users to automatically and accurately calculate and display product content values and identify the raw materials required.

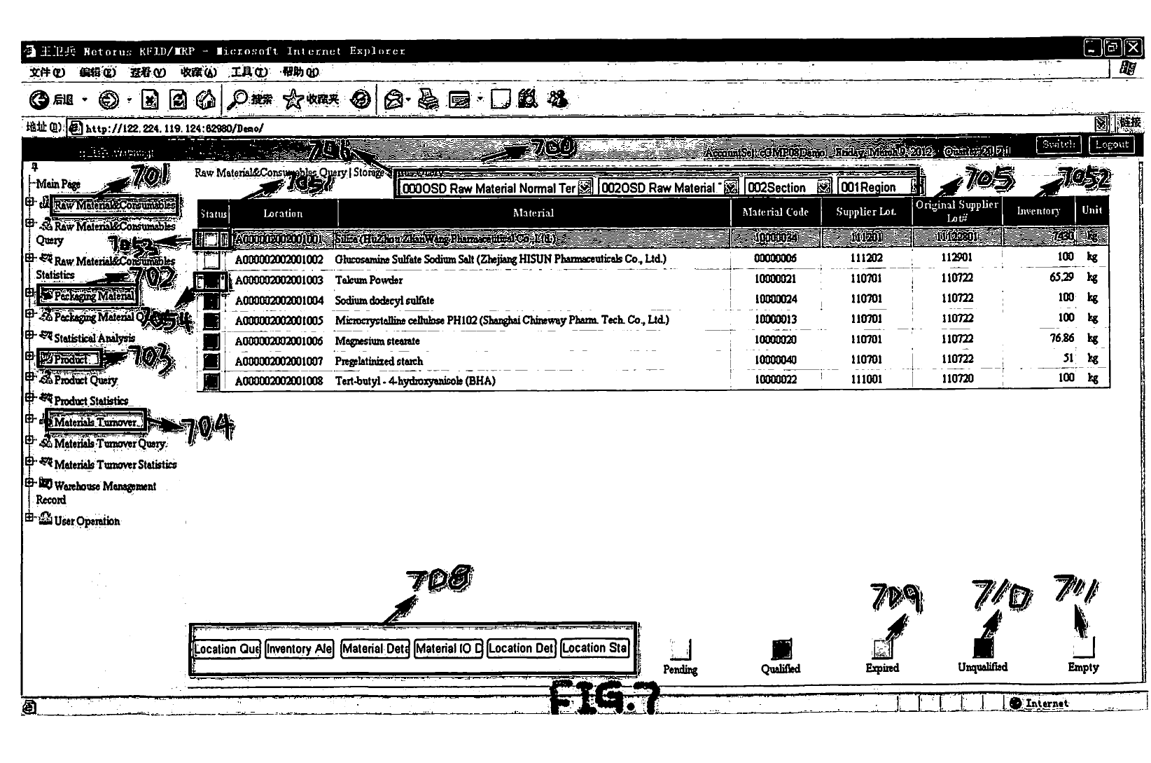

FIG. 7 is a work list screen illustrating captured product raw material information in a repository system having quality status information generated by the inspection system according to the present invention.

Interface 700 includes a list of function items associated with product raw materials, wherein exemplary function items include, but are not limited to, link 701 labeled “raw material and consumables”, link 702 labeled “packaging material”, link 703 labeled “product” and link 704 labeled “material turnover”. When link 701 is initialized, table 705 representing detailed raw materials information associated therein is displayed. In addition, table 705 represents the actual physical location within the raw material and consumables repository where the raw material may be found. Field 706 allows a user to select a different repository to be displayed. According to one exemplary embodiment of the invention, table 705 includes link 7051 labeled “status” that indicates the status of the quality of the corresponding material and link 7052 labeled “inventory” notifies user of the inventory quantity. The specific value shown under link 7052 indicates the actual inventory quantity of certain materials, and can be updated in real-time as described below. Furthermore, quality status data can be transmitted from inspection system and shared with both the repository system and the production system. Under link 7051, different marks denote different material, according to quality status, thus specifying what material is acceptable for release into production For example, mark 7054 is a yellow indicator and thereby indicates that the material has not been inspected. In addition, the marks shown blow table 705, such as red identification mark 710 indicates that the material in the repository is not qualified for use in production. Pink identification mark 709 indicates that the material is outdated, while blank identification 711 indicates that the repository is empty. A set of function buttons below table 705 allow a user to perform several necessary functions associated with raw material placement and location in the repository, that include, but are not limited to, setting inventory alarms, querying raw material location and defining raw material information. When users initialize links 702, 703 and 704, each one function the same as link 701, and, therefore, will not be described herein.

Embodiments within the scope of the present description include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of a process, which may be implemented in one embodiment by a program product including computer-executable instructions, such as program code, executed by computers in networked environments. Generally, program modules include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet.

Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplate

What is claimed is:

1. A computer-based system for integrating a quality inspection system, a production system and a repository system in an automated manufacturing system, comprising:
a storing means for collecting materials information, production information and inspection information related to a product wherein the information is stored in a database;
a linking means for linking the database to a planning system, a materials system, a product quality inspection system and a production system;
a generating means for generating a production plan order by the planning system;
an assigning means for assigning a production task;
a first sending means for sending data concerning production requirements to manufacture a product to the production system;
a second sending means for sending data concerning materials requirement to manufacture a product to the repository system;
a third sending means for sending a materials test sample result to the quality inspection system if the repository system shows that the materials does not meet a pre-set product requirement;
a fourth sending means for sending a test sample result to the quality inspection system to inspect if a product needs to be inspected before a manufacturing process is performed; and
a fifth sending means for sending the inspection result to the material system and the production system.

2. The system of claim 1, wherein the database is linked to an enterprise resource planning (ERP) system and wherein the ERP system shares data with the planning system, materials system, quality control system and the production system.

3. The system of claim 1, wherein test result data is sent to the database from the inspection system.

5. The system of claim 1, wherein the communication among the planning system, the materials system, the control system and the production system is based on the database configuration having a single integrating interface.

6. The system of claim 1, wherein the materials system includes a plurality of colors representing product quality status, wherein a yellow color indicator denotes a quarantine status, a green color indicator denotes pass status and a red indicator denotes an unqualified status.

7. The system of claim 1, wherein the product quality inspection system includes a quality control standards function and quality control process function pre-set by the configuration system.

8. A method for integrating a quality inspection system, a production system and a repository system in a computer-based manufacturing system, comprising:
collecting and storing materials information, production information and inspection information related to a product, wherein the information is stored in a database;
linking the database to a planning system, a materials system, a product quality inspection system and a production system;
a computer program generating a production plan order from the planning system;
the computer program assigning a production task based on the production plan order, sending data concerning production requirements relating to manufacturing of the product to the production system, sending data concerning materials requirement relating to manufacturing of the product to the repository system, sending a materials test sample result to the quality inspection system if the repository system shows that the material does not meet a pre-set production requirement, sending a product test sample result to the quality inspection system if the repository system shows that the product needs to be inspected before a manufacturing process is performed, and sending the materials and product inspection test results to the material system and the production system.

9. The method of claim 8, wherein the database is linked to an enterprise resource planning (ERP) system, wherein the ERP system shares data with the planning system, materials system, quality control system and the production system.

10. The method of claim 8, wherein test result data is sent to the database from the inspection system.

11. The method of claim 8, wherein communication among the planning system, the materials system, the control system and the production system is based on the database configuration having a single integrating interface.

12. The method of claim 8, wherein the materials system includes a plurality of colors representing product quality status, wherein a yellow color indicator denotes a quarantine status, a green color indicator denotes pass status and a red indicator denotes an unqualified status.

13. The method of claim 8, wherein the product quality inspection system includes a quality control standards function and quality control process function pre-set by the configuration system.

14. An apparatus for integrating a quality inspection system, a production system and a repository system in an automated manufacturing system, the apparatus comprising:
a computer-readable memory;
a computer-readable tangible storage device for storing program instructions; and
a processor, to execute program instructions via the computer-readable memory, the program instructions when executed by the processor:
collecting and storing materials information, production information and inspection information related to a product, wherein the information is stored in a database;
linking the database to a planning system, a materials system, a product quality inspection system and a production system;
generating a production plan order from the planning system;
assigning a production task based on the production plan order;
sending data concerning production requirements relating to manufacturing of the product to the production system;
sending data concerning materials requirement relating to manufacturing of the product to the repository system;
sending a materials test sample result to the quality inspection system if the repository system shows that the material does not meet a pre-set production requirement;
sending a product test sample result to the quality inspection system if the repository system shows that the product needs to be inspected before a manufacturing process is performed; and
sending the materials and product inspection test results to the material system and the production system.

15. The system of claim 14, wherein the database is linked to an enterprise resource planning (ERP) system, wherein the ERP system shares data with the planning system, materials system, quality control system and the production system.
